(19) United States
(12) Patent Application Publication
(10) Pub. No.: US 2020/0175269 A1
(43) Pub. Date: Jun. 4, 2020

(54) EYE TRACKER AND DISPLAY

(71) Applicants: STARVR CORPORATION, New Taipei City (TW); Acer Incorporated, New Taipei City (TW)

(72) Inventors: Yen-Hsien Li, New Taipei City (TW); Wei-Kuo Shih, New Taipei City (TW)

(73) Assignees: STARVR CORPORATION, New Taipei City (TW); Acer Incorporated, New Taipei City (TW)

(21) Appl. No.: 16/701,163

(22) Filed: Dec. 3, 2019

(30) Foreign Application Priority Data
Dec. 4, 2018 (TW) 107143415

(51) Int. Cl. G06K 9/00; G02B 27/00; G02B 27/14; G06F 3/01

(52) U.S. Cl. CPC G06K 9/00604; G02B 27/0093; G02B 27/4238; G06F 3/013; G02B 27/14

(57) ABSTRACT

An eye tracker includes a lens, a beam splitter, a structured light source and an image capturing element. The beam splitter is disposed at one side of the lens. The structured light source and the image capturing element are disposed between the lens and the beam splitter. The structured light source is configured to emit a first light and project to the beam splitter. The first light is reflected to the lens from the beam splitter and passes through the lens to project to an eye. The first light is reflected from the eye to form a second light. The second light passes through the lens and projects to the beam splitter, and is reflected to the image capturing element from the beam splitter. A display is also provided.

### CROSS-REFERENCE TO RELATED APPLICATION

This application claims the priority benefit of Taiwan application serial no. 107143415, filed on Dec. 4, 2018. The entirety of the above-mentioned patent application is hereby incorporated by reference herein and made a part of this specification.

### BACKGROUND OF THE DISCLOSURE

### Technical Field

The disclosure relates to an eye tracking technique, and more particularly, to an eye tracker and a display using the same.

### Description of Related Art

The eye tracking technique is usually applied to the display to obtain the changes of the user's eye or the peripheral of the user's eye while the user is watching the display and to determine the changes of the user's eye or the peripheral of the user's eye for the user to interact with the display. In other words, the eye tracking technique may be used to replace the current operating interfaces such as keyboards, mice, touchpads and touch panels.

In the common eye tracker, the light source is mostly disposed around the lens and is disposed at one side of the lens facing the user's eye. Therefore, the light pattern emitted by the light source is quite limited. In addition, in order to concentrate the light emitted by the light source to the eye, it is necessary to configure with a light guiding element corresponding to the light source, but such configuration conflicts with the design requirements of lightness and small size. Also, the error in the alignment of the light guiding element and the light source affects the accuracy of eye tracking.

### SUMMARY OF THE DISCLOSURE

The disclosure provides an eye tracker and a display using the same, which can improve the accuracy of eye tracking.

An eye tracker according to an embodiment of the disclosure includes a lens, a beam splitter, a structured light source and an image capturing element. The beam splitter is disposed at one side of the lens. The structured light source and the image capturing element are disposed between the lens and the beam splitter. The image capturing element is disposed between the lens and the beam splitter, wherein the structured light source is configured to emit a first light and project to the beam splitter, and the first light is reflected to the lens from the beam splitter and passes through the lens to project to an eye. The first light is reflected from the eye to form a second light, wherein the second light passes through the lens and projects to the beam splitter and is reflected to the image capturing element from the beam splitter.

A display according to an embodiment of the disclosure includes the said eye tracker and a display panel. The display panel is disposed at a side of the beam splitter, and the beam splitter is located between the lens and the display panel.

Based on the above, since the eye tracker and the display using the said eye tracker of this disclosure apply the structured light source to track the changes of the eye or the peripheral of the eye, the accuracy of the eye tracking improves. In addition, since the structured light source is disposed between the lens and the beam splitter, the light emitted by the structured light source first projects to the beam splitter and then is reflected to the eye from the beam splitter. Hence, it is not required to configure with an additional light guiding element, thus satisfies the design requirements of lightness and small size.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a display according to an embodiment of the disclosure.

FIG. 2 and FIG. 3 are respectively schematic views of a light pattern generated by a structured light source according to an embodiment of the disclosure.

FIG. 4 is a schematic view of a display according to another embodiment of the disclosure.

### DESCRIPTION OF THE EMBODIMENTS

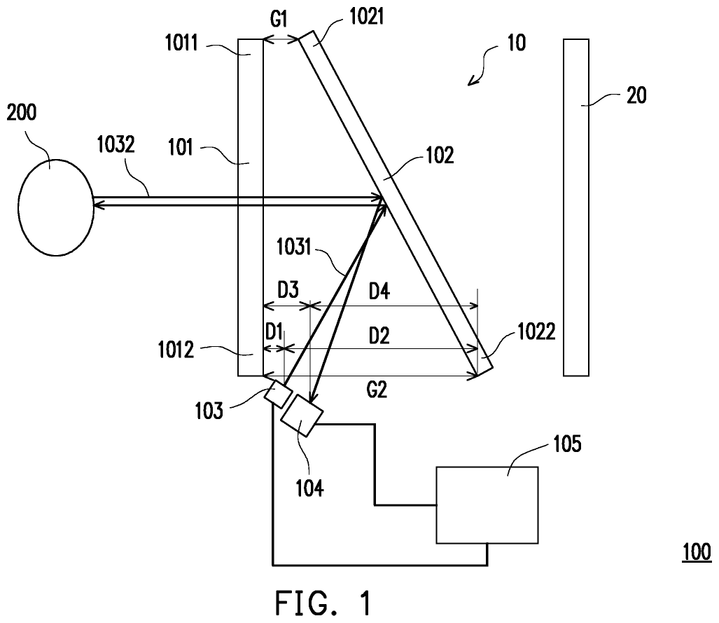

FIG. 1 is a schematic view of a display according to an embodiment of the disclosure. Referring to FIG. 1, in this embodiment, a display 100 includes an eye tracker 10 and a display panel 20, wherein the eye tracker 10 is disposed at one side of the display panel 20, and the eye tracker 10 includes a lens 101, a beam splitter 102, a structured light source 103 and an image capturing element 104. The lens 101, the beam splitter 102 and the display panel 20 are sequentially arranged. In other words, the beam splitter 102 is located between the lens 101 and the display panel 20. The light emitted by the display panel 20 may sequentially passed through the beam splitter 102 and the lens 101 to project to a user's eye 200.

Specifically, the structured light source 103 is disposed between the lens 101 and the beam splitter 102, and the image capturing element 104 is disposed between the lens 101 and the beam splitter 102. The structured light source 103 may be a combination of a laser light and a diffractive optical element (DOE), or a combination of other invisible light and diffractive optical elements, which is not limited in the disclosure. The structured light source 103 is configured to emit a first light 1031. Due to the disposition of the diffractive optical element, the first light 1031 has a specific light pattern, and the design of the light pattern depends on the actual application requirements. On the other hand, since the eye tracker 10 of this embodiment and the display 100 using the said eye tracker 10 apply the structured light source 103 to track the changes of the eye 200 or the peripheral of the eye 200, the accuracy of the eye tracking may improve.

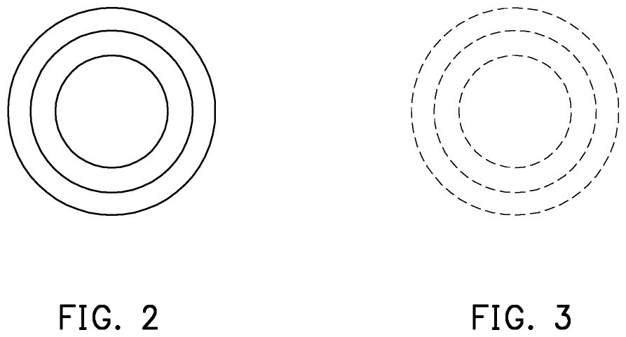

FIG. 2 and FIG. 3 are respectively schematic views of a light pattern generated by a structured light source according to an embodiment of the disclosure. Referring to FIG. 2 and FIG. 3, in an embodiment, a light pattern of the first light 1031 may be composed of a plurality of solid circles (i.e., each circle which is composed of solid line), and the said solid circles may be concentric circles. In another embodiment, a light pattern of the first light 1031 may be composed of a plurality of dashed circles (i.e., each circle which is composed of dashed line), and the said dashed circles may be concentric circles. In other embodiments, a light pattern may be in a shape of a cross, or be composed of a plurality of juxtaposed solid or dashed stripes, but the disclosure is not limited thereto.

Referring to FIG. 1 again, the first light 1031 emitted by the structured light source 103 projects to the beam splitter 102 first, and then is reflected to the lens 101 from the beam splitter 102 and passes through the lens 101 to project to the eye 200. Next, the first light 1031 is reflected from the eye 200 to form a second light 1032, wherein the second light 1032 passes through the lens 101 and projects to the beam splitter 102, and is reflected to the image capturing element 104 from the beam splitter 102. Since the structured light source 103 is disposed between the lens 101 and the beam splitter 102, the light emitted by the structured light source 103 projects to the beam splitter 102 first and then is reflected to the eye 200 from the beam splitter 102. As such, it is not required to configure with an additional light guiding element, thus satisfies the design requirements of lightness and small size.

In this embodiment, the eye tracker 10 further includes a processor 105, and the structured light source 103 and the image capturing element 104 are electrically coupled to the processor 105. the processor 105 may be a central processing unit (CPU), a system on chip (SOC), or other programmable microprocessor for general or special use, a digital signal processor (DSP), a programmable controller, an application specific integrated circuit (ASIC), a programmable logic device (PLD), other similar devices, or a combination of these devices for controlling the light emission of the structured light source 103 and receiving and processing the image signals.

Furthermore, after receiving the second light 1032, the image capturing element 104 converts the second light 1032 into an image signal, and then transmits the image signal to the processor 105. Then, the processor 105 performs arithmetic processing on the image signal received. Since the change of the eye 200 or the peripheral of the eye 200 jointly changes the reflected light, the processor 105 compares the light pattern of the emitted light (i.e., the first light 1031) with the light pattern of the reflected light (i.e., the second light 1032) to determine the change of the eye 200 or the peripheral of the eye 200.

In this embodiment, the lens 101 has a first lens end 1011 and a second lens end 1012 opposed to each other, and the beam splitter 102 has a first beam splitter end 1021 and a second beam splitter end 1022 opposed to each other. The first beam splitter end 1021 is disposed correspondingly to the first lens end 1011, and the second beam splitter end 1022 is disposed correspondingly to the second lens end 1012. On the other hand, the structured light source 103 and the image capturing element 104 are disposed at a side of the second lens end 1012, and the structured light source 103 is disposed between the second lens end 1012 and the image capturing element 104. In other words, the structured light source 103 is located closer to the second lens end 1012 than the image capturing element 104 is.

Specifically, there is a first gap G1 between the first beam splitter end 1021 and the first lens end 1011 and a second gap G2 between the second beam splitter end 1022 and the second lens end 1012. The second gap G2 is larger than the first gap G1, as shown in FIG. 1. The beam splitter 102 is inclined to the juxtaposed lens 101 and the display panel 20. On the other hand, the structured light source 103 and the image capturing element 104 are disposed in the second gap G2, wherein the structured light source 103 is spaced apart from the second lens end 1012 by a first distance D1, the structured light source 103 is spaced apart from the second beam splitter end 1022 by a second distance D2, the image capturing element 104 is spaced apart from the second lens end 1012 by a third distance D3, and the image capturing element 104 is spaced apart from the second beam splitter end 1022 by a fourth distance D4. The second distance D2 is greater than the first distance D1, the fourth distance D4 is greater than the third distance D3, and the third distance D3 is greater than the first distance D1.

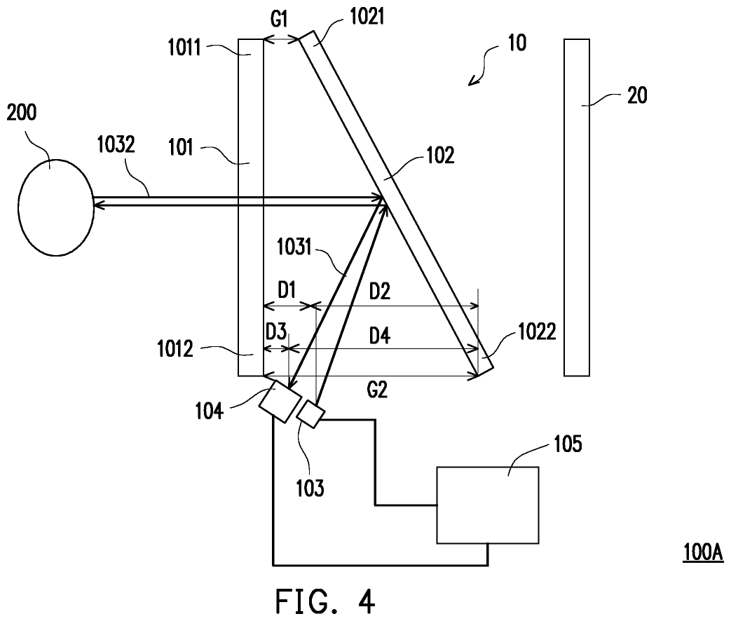

FIG. 4 is a schematic view of a display according to another embodiment of the disclosure. Referring to FIG. 4, a display 100A in this embodiment is roughly the same as the display 100 in the previous embodiment, and only the differences between the two will be described below. In this embodiment, the image capturing element 104 is located between the second lens end 1012 and the structured light source 103. Furthermore, the third distance D3 between the image capturing element 104 and the second lens end 1012 is smaller than the first distance D1 between the structured light source 103 and the second lens end 1012.

In sum of the above, since the eye tracker and the display using the said eye tracker of this disclosure apply the structured light source to track the changes of the eye or the peripheral of the eye, the accuracy of the eye tracking improves. In addition, since the structured light source is disposed between the lens and the beam splitter, the light emitted by the structured light source first projects to the beam splitter and then is reflected to the eye from the beam splitter. Hence, it is not required to configure with an additional light guiding element, thus satisfies the design requirements of lightness and small size.

It will be apparent to those skilled in the art that various modifications and variations can be made to the disclosed embodiments without departing from the scope or spirit of the disclosure. In view of the foregoing, it is intended that the disclosure covers modifications and variations of this disclosure provided that they fall within the scope of the following claims and their equivalents.

What is claimed is:

1. An eye tracker, comprising:
a lens;
a beam splitter, disposed at a side of the lens;
a structured light source, disposed between the lens and the beam splitter; and
an image capturing element, disposed between the lens and the beam splitter, wherein the structured light source is configured to emit a first light and project to the beam splitter, the first light is reflected to the lens from the beam splitter and passes through the lens for projecting to an eye, the first light is reflected from the eye for forming a second light, wherein the second light passes through the lens and projects to the beam splitter and is reflected to the image capturing element from the beam splitter.

2. The eye tracker according to claim 1, wherein the lens has a first lens end and a second lens end opposed to each other, and the beam splitter has a first beam splitter end and a second beam splitter end opposed to each other, the first beam splitter end is disposed in correspondence to the first lens end, and the second beam splitter end is disposed in correspondence to the second lens end.

3. The eye tracker according to claim 2, wherein a first gap exists between the first beam splitter end and the first lens end, and a second gap exists between the second beam splitter end and the second lens end, the second gap is larger than the first gap.

4. The eye tracker according to claim 3, wherein the structured light source and the image capturing element are disposed in the second gap.

5. The eye tracker according to claim 4, wherein the structured light source is spaced apart from the second lens end by a first distance, and the structured light source is spaced apart from the second beam splitter end by a second distance, the second distance is greater than the first distance.

6. The eye tracker according to claim 5, wherein the image capturing element is spaced apart from the second lens end by a third distance, and the image capturing element is spaced apart from the second beam splitter end by a fourth distance, the fourth distance is greater than the third distance, and the third distance is greater than the first distance.

7. The eye tracker according to claim 5, wherein the image capturing element is spaced apart from the second lens end by a third distance, and the image capturing element is spaced apart from the second beam splitter end by a fourth distance, the fourth distance is greater than the third distance, and the third distance is smaller than the first distance.

8. The eye tracker according to claim 2, wherein the structured light source and the image capturing element are disposed at a side of the second lens end, and the structured light source is located between the second lens end and the image capturing element.

9. The eye tracker according to claim 2, wherein the structured light source and the image capturing element are disposed at a side of the second lens end, and the image capturing element is located between the second lens end and the structured light source.

10. A display, comprising:
an eye tracker, comprising:
a lens;
a beam splitter, disposed at a side of the lens;
a structured light source, disposed between the lens and the beam splitter; and
an image capturing element, disposed between the lens and the beam splitter, wherein the structured light source is configured to emit a first light and project to the beam splitter, the first light is reflected to the lens from the beam splitter and passes through the lens for projecting to an eye, the first light is reflected from the eye for forming a second light, wherein the second light passes through the lens and projects to the beam splitter and is reflected to the image capturing element from the beam splitter; and
a display panel, disposed at a side of the beam splitter, and the beam splitter is disposed between the lens and the display panel.
